(19) United States
(12) Patent Application Publication
(10) Pub. No.: US 2024/0085633 A1
(43) Pub. Date: Mar. 14, 2024

(54) CONFIGURABLE OPTICAL CONNECTOR MODULE

(71) Applicant: Senko Advanced Components, Inc., Hudson, MA (US)

(72) Inventors: Yang CHEN, Thousand Oaks, CA (US); Robert Ryan VALLANCE, Newbury Park, CA (US)

(21) Appl. No.: 18/467,449

(22) Filed: Sep. 14, 2023

Related U.S. Application Data
(60) Provisional application No. 63/406,621, filed on Sep. 14, 2022.
(60) Provisional application No. 63/420,042, filed on Oct. 27, 2022.
(60) Provisional application No. 63/492,704, filed on Mar. 28, 2023.

(51) Int. Cl. G02B 6/36

(52) U.S. Cl. CPC G02B 6/3616; G02B 6/364

(57) ABSTRACT

An optical connector module having a plurality of discrete optical benches inputting/outputting optical signals, each including: a base defining an array of reflective surfaces and supporting an array of optical fiber array defining optical channels with inputs/outputs in optical alignment with corresponding reflective surfaces, thereby forming optical inputs/outputs of the corresponding optical bench. A carrier commonly supports the optical benches, with the optical benches fixedly mount thereon in a desired spatial arrangement with the optical inputs/outputs of the optical benches matching optical inputs/outputs of the external optical component. The carrier is structured to physically connect to the external component. The carrier includes passive alignment features for demountable coupling to the external component, wherein the carrier is at least one of directly mounted to the top of the external component, or detachably mounted to the external component via a receptacle or foundation positioned relative to the inputs/outputs of the external component.

### BACKGROUND OF THE INVENTION

### Priority Claim

This application claims the priorities of (a) U.S. Provisional Patent Application No. 63/406,621 filed on Sep. 14, 2022; (b) U.S. Provisional Patent Application No. 63/420,042 filed on Oct. 27, 2022; and (c) U.S. Provisional Patent Application No. 63/492,704 filed on Mar. 28, 2023. These applications are fully incorporated by reference as if fully set forth herein. All publications noted below are fully incorporated by reference as if fully set forth herein.

### FIELD OF THE INVENTION

The present invention relates to coupling of light into and out of optoelectronic components (e.g., photonic integrated circuits (PICs)), and more particular to the optical connection of optical fibers to PICs.

### Description of Related Art

Photonic integrated circuits (PICs) or integrated optical circuits are part of an emerging technology that uses light as a means of communication as opposed to an electric current. A PIC device integrates multiple (at least two) photonic functions and as such is analogous to an electronic integrated circuit. The major difference between the two is that a photonic integrated circuit provides functionality for information signals imposed on optical wavelengths typically in the visible spectrum or near infrared 850 nm-1650 nm.

PICs are used for various applications in telecommunications, instrumentation, sensing, and signal-processing fields. A PIC device (e.g., in the form of a silicon photonic chip package referred to as SiPIC) typically uses optical waveguides to route optical signals and/or interconnect various on-chip elements, such as optical switches, couplers, routers, splitters, multiplexers/demultiplexers, modulators, amplifiers, wavelength converters, optical-to-electrical (O/E) and electrical-to-optical (E/O) signal converters (e.g., photodiodes, lasers), etc. A waveguide in a PIC device is usually an on-chip solid light conductor that guides light due to an index-of-refraction contrast between the waveguide's core and cladding.

For proper operation, a PIC typically needs to efficiently couple light between an external optical fiber and one or more of on-chip waveguides. Given an advantage of using light as a basis of circuit operation in a PIC device is that its energy cost for high-speed signal transmission is substantially less than that of electronic chips, thus efficient coupling between PIC devices and other optical devices, such as optical fibers, that maintains this advantage is an important aspect of PICs.

One of the most expensive components within photonic networks is the fiber-optic connectors. The current state-of-the-art attempts to achieve stringent alignment tolerances using polymer connector components, but polymers have several fundamental disadvantages. First, they are elastically compliant so that they deform easily under external applied loads. Second, they are not dimensionally stable and can change size and shape especially when subjected to elevated temperatures such as those found in computing and networking hardware. Third, the coefficient of thermal expansion (CTE) of polymers is much larger than the CTE of materials that are commonly used in PIC devices. Therefore, temperature cycles cause misalignment and mechanical stress between the optical fibers and the optical elements on the PIC devices. In some cases, like wave soldering, the polymers cannot withstand the processing temperatures used while soldering PIC devices onto printed circuit boards.

Furthermore, PIC devices may have many optical input/output configurations, which would require optical connectors to be designed to be compatible with the optical input/output configurations of the PIC devices. Each application and PIC likely requires different spatial locations of the optical I/O ports, and this is challenging for standardization in the fiber-optic connectors.

In recent development of photonic devices, optical multichip modules (MCMs) are being implemented to allow multiple integrated circuits and multiple PICs to be modularly incorporated into larger complex packages. This helps improve yields over a conventional monolithic integrated circuits. A multi-chip module (MCM) consists of multiple PICs mounted onto a unifying common support (e.g., an organic PCB or glass interposer), which may include other discrete components, so that in use it can be treated as if it were an overall larger PIC. For example, the MCM may contain an ASIC (e.g., at the center of MCM) with memory stacks and/or PICs surrounding the ASIC. In the MCM, optical signal input/output (I/O) units are provided on the surface or edges of the PICs.

For MCMs having multiple PICs, and PICs that can have different optical input/output I/O configurations (e.g., different number of I/O channels and different locations on the PIC), it is a further design challenge to accommodate optical and mechanical connections to the multiple PICs in an MCM. Given the different optical I/O configurations in the multiple chips, different optical connectors of different matching I/O configurations are required, which would lead to more tedious processes to implement connections of the different optical connectors to the multiple PICs in an MCM. Once the connection is made, it is permanent, and would not be demountable, separable or detachable without likely destroying the integrity of connection for any hope of remounting the optical fiber array to the PICs. In other words, the optical fiber array is not removably attachable to the PIC, and the fiber array connection, and separation would be destructive and not reversible (i.e., not reconnectable).

The common assignee of the present application, Senko Advanced Components, Inc., developed proprietary metallic PIC connector (MPC) that overcame the above noted short comings of polymer connector components. MPC improves optical and mechanical compatibility of optical connectors to PIC devices.

US Patent Publication No. 2016/0161686A1 (commonly assigned to the assignee of the present application, and fully incorporated by reference herein) discloses demountable metallic optical connectors for optoelectronic devices. The disclosed demountable optical connectors include implementation of an elastic averaging coupling to provide an improved approach to optically couple input/output of optical fibers to PICs which improves tolerance, manufacturability, ease of use, functionality and reliability at reduced costs. In a well-designed and preloaded elastic averaging coupling, the repeatability is approximately inversely proportional to the square root of the number of contact points.

What is needed is an improved optical connector for PIC devices, in particular MCMs, preferably with an improved demountable mechanical coupling for connecting optical connectors to multiple PICs in an MCM, which improves flexibility, tolerance, manufacturability, ease of use, functionality and reliability at reduced costs.

### SUMMARY OF THE INVENTION

The present invention overcomes the drawbacks of the prior art by providing an improved optical connector module for optically coupling to an external component, e.g., a PIC device, such as within an MCM, which provides flexibility to preconfigure optical benches in the optical connector module to match the optical input/output locations/configurations in the external optical component. A demountable mechanical coupling may be implemented to further provide flexibility, tolerance, manufacturability, ease of use, functionality and reliability at reduced costs. Processes are developed to achieve accurate assembling of optical connector modules with optical benches in optical alignment to the optical input/output locations/configurations in the external optical component.

With the foregoing as introduction, the present invention may be summarized below will be explained in connection with the illustrated embodiments.

In one aspect of the present invention, the optical connector module comprises a plurality of discrete optical benches inputting/outputting optical signals, each comprising: a base defining an array of reflective surfaces and supporting an array of optical waveguides (e.g., optical fiber array) defining optical channels with inputs/outputs in optical alignment with corresponding reflective surfaces, thereby forming optical inputs/outputs of the corresponding optical bench. A carrier commonly supports the optical benches, with the optical benches fixedly attached thereon in a desired spatial arrangement with the optical inputs/outputs of the optical benches matching the configuration of optical inputs/outputs of the external optical component. The carrier is structured to physically connect to the external component. With the connector module connected to the external optical component, optical signals are coupled between the optical waveguides in the optical benches and the external component.

In one embodiment, at least two of the plurality of optical benches are structured to support different number of waveguides to define different number of channels of the respective optical benches. In a further embodiment, at least two of the optical benches are arranged in a lateral configuration across the carrier, with the optical channels laterally arranged across the two optical benches. In one embodiment, the optical benches are arranged with optical inputs/outputs in a substantially colinear arrangement.

In one embodiment, at least one of the optical benches is a metallic optical bench, wherein the base is metal, with each reflective surface defined as a reflective freeform optical surface exposed facing away from the base, turning incident light of an optical signal by a non-zero angle and/or reshaping the mode field of the incident light of the optical signal.

In one embodiment, the carrier comprises interfacing features for physical mating connection to the external component. For example, the interfacing features may comprise passive alignment features matching complementary passive alignment features on the external component for demountable coupling of the connector module to the external component. The carrier is either directly mounted to the top of the external component, detachably mounted to the external component (e.g., via a receptacle or foundation positioned relative to the inputs/outputs of the external component, wherein the receptacle may be mounted to the top of the external component or the foundation located near an edge of the external component). The receptacle may comprise a foundation located near an edge of the external component. The carrier may be directly mounted to the top of the external component or detachably mounted to the external component via a receptacle or foundation positioned in reference to the inputs/outputs at the top of the external component (e.g., mounted to the top of the external component or located near an edge of the external component).

In one embodiment, the carrier comprises a backplate commonly attached to the bases of the optical benches on a side not facing the external component. One side of the backplate, facing the external component, comprises the passive alignment features. The backplate may be configured to be detachably mounted directly to the top of the external component where complementary passive alignment features are defined matching the passive alignment features on the backplate. In an alternate embodiment, the backplate is detachably mounted to the external component via a receptacle attached to a top of the external component or positioned near an edge of the external component, wherein the receptacle comprises complementary passive alignment features matching the passive alignment features on the backplate.

In a further embodiment, the carrier further comprises a cover plate (e.g., silicon or metal cover plate) commonly mounted to the bases of the optical benches on a side with the inputs/outputs of the optical signals, wherein a side of the cover plate facing the external component comprises the passive alignment features. The optical benches are sandwiched between the backplate and cover plate of the carrier. The carrier may be configured to be detachably mounted directly to the top of the external component where complementary passive alignment features are defined matching the complementary alignment features on the cover plate. In an alternate embodiment, the cover plate is detachably mounted to the external component via a receptacle attached to a top of the external component or positioned at an end of the external component, wherein the receptacle comprises complementary passive alignment features matching the complementary passive alignment features on the cover plate.

In one embodiment, the external component comprises another optical connector module of similar structure, whereby the two optical connector modules may be optically coupled to communicate optical signals. In another embodiment, the external component comprises an optical device, which may be a photonic integrated circuit (PIC), and further which may be a multichip module (MCM) comprising a plurality of discrete PICs mounted on a unifying common support.

In one embodiment, at least one optical bench supports waveguides that comprise an array of optical fibers, and the base of the at least one optical bench includes an array of alignment features supporting the array of optical fibers with their longitudinal axis in a plane.

In one embodiment, the passive alignment features comprise elastic averaging features.

In one embodiment, the passive alignment features comprise a kinematic coupling.

In one embodiment, the surface features of the optical bench and/or the passive alignment features are formed by metal stamping a body made of a malleable metal material.

In another embodiment the surface features used in the passive alignment are etched into silicon.

In another embodiment the surface features used in passive alignment are molded into glass.

Another aspect of the present invention is directed to a method of assembling an optical connector module for optical coupling to an external component, comprising providing a plurality of discrete optical benches inputting/outputting optical signals, each comprising: a base defining an array of reflective surfaces and supporting an array of optical waveguides defining optical channels with inputs/outputs in optical alignment with corresponding reflective surfaces, thereby forming optical inputs/outputs of the optical bench. The optical benches are commonly supported on a carrier by fixedly mounting the optical benches on the carrier in a desired spatial arrangement with the optical inputs/outputs of the optical benches matching optical inputs/outputs of the external optical component. The carrier is structured to physically connect to the external component, whereby with the connector module connected to the external optical component, optical signals are coupled between the optical waveguides in the optical benches and the external component.

A further aspect of the present invention is directed to a method of optically coupling waveguides to an external component, comprising: providing a plurality of discrete optical benches inputting/outputting optical signals, each comprising: a base defining an array of reflective surfaces and supporting an array of optical waveguides defining optical channels with inputs/outputs in optical alignment with corresponding reflective surfaces, thereby forming optical inputs/outputs of the optical bench. An assembly form is provided which conforms to optical inputs/outputs and passive alignment features corresponding to the external component that is to be optically coupled with the waveguides. The optical benches are actively aligned to the assembly form. The carrier is fixedly mounted to the optical benches after the optical benches have been actively aligned to the assembly form to form an optical connector module, wherein the carrier is commonly attached to the bases of the optical benches on a side not facing the external component. The carrier is structured to physically connect to the external component, wherein upon mounting the optical benches to the carrier, the optical inputs/outputs of the optical benches matching optical inputs/outputs of the external optical component. The optical connector module so assembled is then removed from the assembly form. With the connector module connected to the external optical component, optical signals are coupled between the optical waveguides in the optical benches and the external component.

In a further embodiment, the carrier comprises passive alignment features matching complementary passive alignment features on the external component for demountable coupling of the connector module to the external component, wherein the carrier is directly mounted to the top of the external component or detachably mounted to the external component via a receptacle attached to a top of the external component. The carrier may comprise a backplate commonly attached to the bases of the optical benches on a side not facing the external component, wherein a side of the backplate facing the external component comprises the passive alignment features. The backplate is detachably mounted directly to the top of the external component where passive alignment features are defined matching the complementary passive alignment features on the backplate, or wherein the backplate is detachably mounted to the external component via a receptacle attached to a top of the external component, wherein the receptacle comprises the complementary passive alignment features matching the passive alignment features on the backplate.

In a further embodiment, the carrier further comprises a cover plate (e.g., silicon cover plate) commonly mounted to the bases of the optical benches on a side with the inputs/outputs of the optical signals, wherein a side of the cover plate facing the external component comprises the passive alignment features. The carrier is detachably mounted directly to the top of the external component where complementary passive alignment features are defined matching the passive alignment features on the cover plate, or wherein the cover plate is detachably mounted to the external component via a receptacle attached to a top of the external component, wherein the receptacle comprises the complementary passive alignment features matching the passive alignment features on the cover plate.

In one embodiment, the assembly form conforms to optical inputs/outputs and passive alignment features corresponding to the external component by providing the same grating coupling position and alignment features as the external component that is to be optically coupled with the waveguides, and further providing a loopback optical waveguides connection for active alignment of the optical benches.

In a further embodiment, the external component comprises a multichip module (MCM) comprising a plurality of discrete PICs mounted on a unifying common support, wherein the assembly form comprises PICs that mimic actual PICs used in the MCM to facilitate active alignment of the optical benches for assembling the optical connector module. The assembly form further comprises passive alignment features. The passive alignment features are provided on the top of the MCM, or provided on an assembly receptacle attached to the top of the MCM

With the foregoing summary as introduction, the present invention may be further discussed below to support the features recited in the claims.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1A is a schematic plan view of an underside of an optical connector module with the optical benches exposed, in accordance with one embodiment of the present invention; FIG. 1B is a schematic plan view of an opposite top side of another similarly structured optical connector module with the optical benches hidden from view, in accordance with one embodiment of the present invention; FIG. 1C is a schematic plan view of the optical connector module shown in FIG. 1A optically coupled to the optical connector module shown in FIG. 1B.

FIG. 2A illustrates an optical bench supporting an array of optical fibers, in accordance with one embodiment of the present invention; FIG. 2B illustrates the optical bench shown in FIG. 2A with a glass cover plate, in accordance with another embodiment of the present invention.

FIG. 3A is a schematic top plan view of a PIC inside an optical multichip module (MCM) with a foundation near an edge thereof, in accordance with one embodiment of the present invention; FIG. 3B is a schematic plan view of a top side of an optical connector module with the optical benches hidden from view, in accordance with one embodiment of the present invention;

FIG. 3C is a schematic plan view of the optical connector module of FIG. 3B optically coupled to the foundation shown in FIG. 3A; FIG. 3D is an alternate embodiment in which the optical connector module is permanently attached to the MCM.

FIG. 4A is a perspective view of an optical connector module optically coupled to a PIC within an MCM, in accordance with one embodiment of the present invention; FIG. 4B is a top plan view of FIG. 4A; FIG. 4C is a top plan view of the MCM and the foundation having passive alignment features, in accordance with one embodiment of the present invention; FIG. 4D is a plan view of an underside of the optical connector module shown in FIG. 4A with the optical benches exposed, in accordance with one embodiment of the present invention; FIG. 4E schematically illustrates the relative dimensions and positions of the inputs/outputs on either the surface of the PIC or the optical fibers supported in the optical benches shown in FIG. 4D.

FIG. 5A is a perspective view of an optical connector module optically coupled to an MCM, in accordance with one embodiment of the present invention; FIG. 5B is a perspective view of an optical connector module optically coupled to the MCM adjacent to a heat spreader, in accordance with one embodiment of the present invention.

FIG. 6A illustrates elastic averaging passive alignment features provided on a top surface of an MCM, in accordance with one embodiment of the present invention; FIG. 6B illustrates elastic averaging passive alignment features provided on a cover plate to be attached to the underside of an optical connector module, in accordance with one embodiment of the present invention; FIG. 6C schematically illustrates the mating of the elastic averaging features when the optical connector module is demountably coupled to the top surface of the MCM; FIG. 6D is a sectional view along line 6D-6D in FIG. 6C.

FIG. 7A illustrates demountable coupling of an optical connector module having a cover plate to an MCM, in accordance with one embodiment of the present invention; FIG. 7B is a sectional view.

FIGS. 8A to 8E illustrate the process of assembling the optical connector module shown in the embodiment of FIGS. 7A and 7B, in accordance with one embodiment of the present invention.

FIG. 9A illustrates demountable coupling of an optical connector module having a cover plate to an MCM via a receptacle, in accordance with one embodiment of the present invention; FIG. 9B is a sectional view.

FIGS. 10A to 10D illustrate the process of assembling the optical connector module shown in the embodiment of FIGS. 9A and 9B, in accordance with one embodiment of the present invention.

FIG. 11A illustrates demountable coupling of an optical connector module to an MCM, in accordance with one embodiment of the present invention; FIG. 11B is a sectional view.

FIGS. 12A to 12E illustrate the process of assembling the optical connector module shown in the embodiment of FIGS. 11A and 11B, in accordance with one embodiment of the present invention.

FIG. 13A illustrates demountable coupling of an optical connector module to an MCM via a receptacle, in accordance with one embodiment of the present invention; FIG. 13B is a sectional view.

FIGS. 14A to 14D illustrate the process of assembling the optical connector module shown in the embodiment of FIGS. 13A and 13B, in accordance with one embodiment of the present invention.

FIG. 15A schematically illustrates complementary elastic averaging features at opposing mating surfaces at the optical connector side and the foundation side, in accordance with one embodiment of the present invention; FIGS. 15B and 15C illustrate perspective and side views of demountable coupling between the connector and the foundation.

FIG. 16A schematically illustrates the contact points between complementary arrays of elastic averaging features, in accordance with one embodiment of the present invention; FIG. 16B is a schematic perspective view illustrating contacts between complementary bumps in the complementary arrays of elastic averaging features, in accordance with one embodiment of the present invention; FIG. 16C is a schematic graphical view illustrating contacts between complementary bumps in the complementary arrays of elastic averaging features, in accordance with one embodiment of the present invention.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

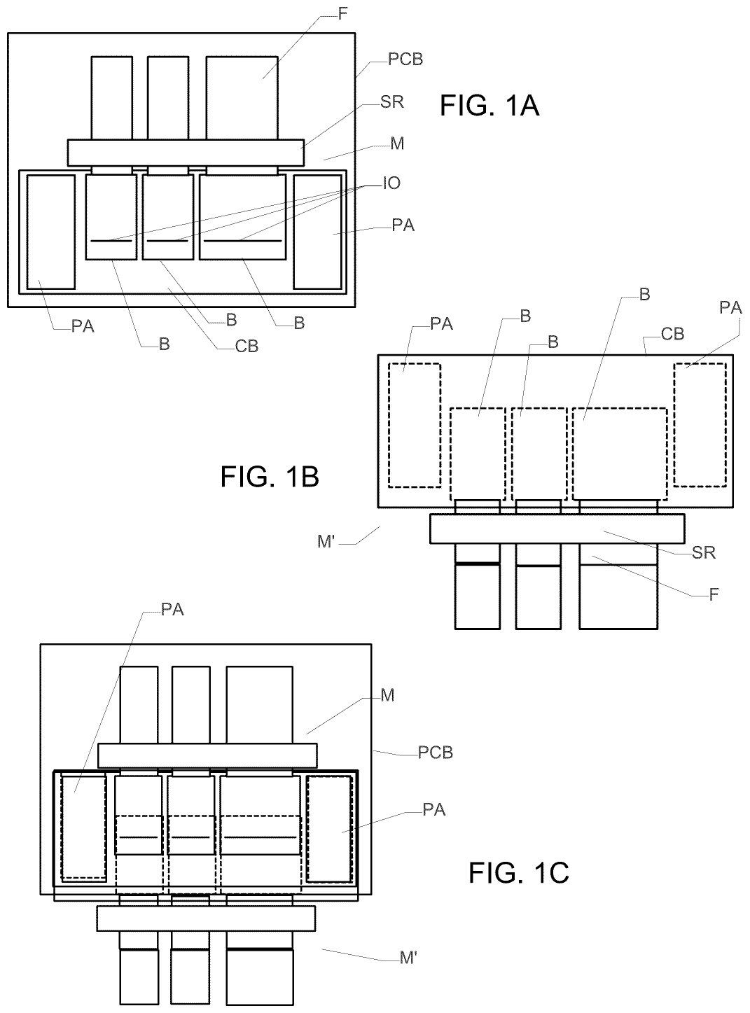

The general configuration of the inventive configurable optical connector module M will be discussed in reference to FIGS. 1 to 4. FIG. 1A is a schematic plan view of an underside of an optical connector module M with the optical benches B exposed, in accordance with one embodiment of the present invention. In FIG. 1A, the optical connector module M comprises a plurality of discrete optical benches B inputting/outputting optical signals, which are commonly supported by a carrier. The carrier comprises a backplate CB that commonly supports the optical benches B, with the optical benches B fixedly mounted thereon in a desired spatial arrangement with the optical inputs/outputs IO of the optical benches B matching existing optical inputs/outputs (e.g., light input and output grating couplers) of the external optical component. With the connector module M connected to the external optical component, optical signals are coupled between the optical waveguides (e.g., in the form of optical fibers F) in the optical benches and the external component. A strain relief SR is provided to hold the fiber cable comprising optical fibers F. In one embodiment, the carrier comprises interfacing features for physical mating connection to the external component. For example, the interfacing features may comprise passive alignment features matching complementary passive alignment features on the external component on the external component for demountable coupling of the connector module to the external component.

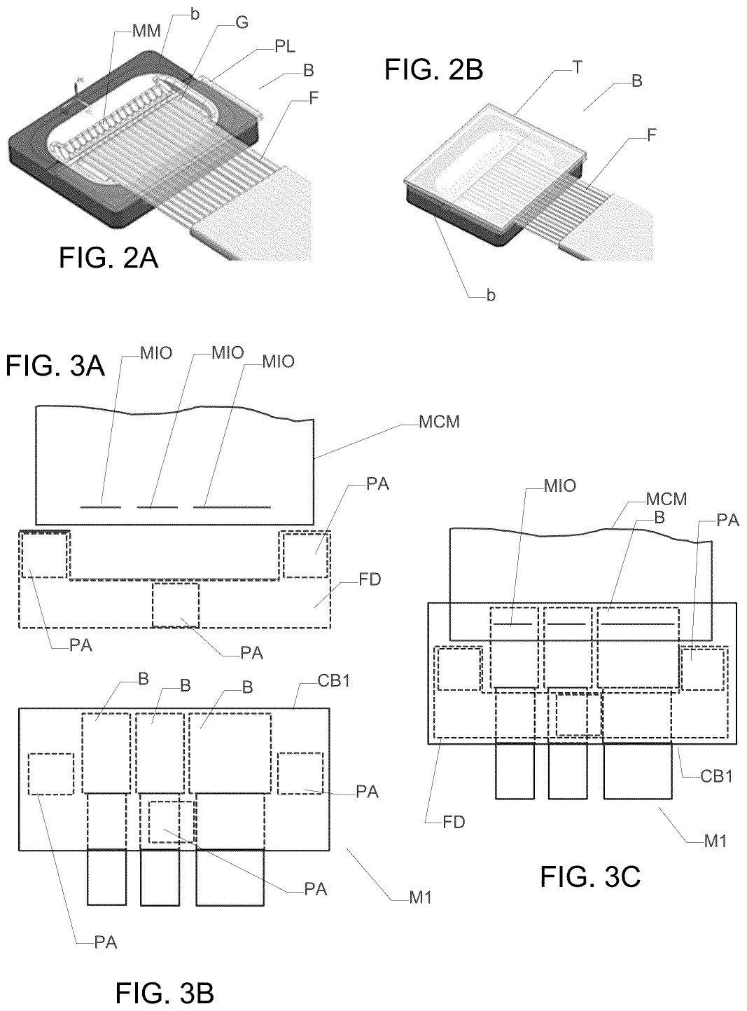

The optical benches B can be configured similar to the optical benches B shown in FIGS. 2A and 2B. As shown in FIG. 2A, the optical bench B includes an array of micromirrors MM defined which correspond to an array of waveguides in the form of optical fibers F. In the illustrated embodiment, the optical bench B comprises a base or body b supporting the array of optical fiber F transmitting an optical signal. The optical bench accurately supports the exit ends of the optical fibers F with respect to the micromirror array M, and further in reference to the exterior (e.g., the top side in FIG. 1B) of the body b. The body b thus provides an alignment reference to the mirrors MM and the optical fibers F. As will be further explained below, the optical bench B aligns the optical fiber F to communicate optical signals with an external component (e.g., another optical connector module or an external optoelectronic device (e.g., a PIC chip, or an I/O PIC chip for an ASIC chip (e.g., CPU, GPU, switch ASIC, or an optical multichip module (MCM).

More specifically, the body b of the optical bench B defines structured features including an alignment structure comprising open grooves G for retaining bare sections of optical fibers F (having cladding exposed, without protective buffer and matrix/jacket layers), and structured reflective surfaces (e.g., eight, twelve, eighteen, or twenty mirrors MM). The open grooves G are sized to receive and located to precisely position the end section of the optical fibers F in alignment with respect to the array of mirrors MM along an optical path. The end face (input/output end) of each of the optical fibers F is maintained at a pre-defined distance with respect to a corresponding mirror MM. A clamping plate PL is provided to retain the optical fibers F in the respective grooves G, e.g., by clamping the optical fibers F against the grooves G.

In the illustrated embodiment of FIG. 2B, a transparent glass, quartz, sapphire, or silicon plate cover T is further provided to cover the exposed surfaces on the optical bench B to protect the mirrors MM. In one embodiment, the optical bench B may be filled with index-matching epoxy between the mirror surfaces MM and the plate cover T.

In one embodiment, each mirror MM is an exposed free surface of the base b of the optical bench B (i.e., a surface exposed to air, or not internal within the body of the base of the optical bench) having an exposed reflective free side facing away from the body B. The exposed reflective free side comprises a structured reflective surface profile at which light is directed to and from the optical fiber F and to and from the external component to which the connection module M optically coupled Each mirror MM bends, reflects (e.g., by a non-zero angle such as 90 degrees) and/or reshapes an incident light. Depending on the geometry and shape (e.g., curvature) of the structured reflective surface profile, the mirrors MM may collimate, expand, or focus an incident light beam. For example, the structured reflective surface profile may comprise one of the following geometrical shape/profiles: (a) ellipsoidal, (b) off-axis parabolic, or (c) other free-form optical surfaces. For example, the mirror surface, to provide optical power, may have a surface geometrical curvature function of any of the following, individually, or in superposition: ellipsoidal or hyperbolic conic foci, toroidal aspheric surfaces with various number of even or odd aspheric terms, X-Y aspheric curves with various number of even or off terms, Zernike polynomials to various order, and various families of simpler surfaces encompassed by these functions. The surfaces may also be free-form surfaces with no symmetry along any plane or vector. The mirrors MM may be defined on the body b by stamping a malleable metal material. Various malleable metals, stampable with tool steels or tungsten carbide tools, may compose the body of the mirrors, including any 300 or 400 series stainless steel, any composition of Kovar, any precipitation or solution hardened metal, and any alloy of Ag, Al, Au, Cu. At the long wavelengths above 1310 nm, aluminum is highly reflective (>98%) and economically shaped by stamping. The reflective surface of the portion of the metal comprising the optical bench B may be any of the metals mentioned above, or any coating of highly reflective metal, applied by sputtering, evaporation, or plating process.

Several earlier patent disclosures commonly assigned to the assignee of the present application may be reference for stamp forming the optical benches B.

U.S. Patent Application Publication No. US2015/0355420A1 discloses an optical coupling device in the form of an optical bench for routing optical signals for use in an optical communications module, in particular an optical coupling device in the form of an optical bench, in which defined on a metal base is a structured surface having a surface profile that bends, reflects and/or reshapes an incident light. An alignment structure is defined on the base, configured with a surface feature to facilitate positioning an optical component (e.g., an optical fiber) on the base in optical alignment with the structured surface to allow light to be transmitted along a defined path between the structured surface and the optical component. The structured surface and the alignment structure are integrally defined on the base by stamping a malleable metal material of the base. The alignment structure facilitates passive alignment of the optical component on the base in optical alignment with the structured surface to allow light to be transmitted along a defined path between the structured surface and the optical component.

U.S. Pat. No. 7,343,770 discloses a novel precision stamping system for manufacturing small tolerance parts. Such inventive stamping system can be implemented in various stamping processes to produce the components disclosed herein. These stamping processes involve stamping a bulk material (e.g., a metal blank), to form the final overall geometry and geometry of the surface features at tight (i.e., small) tolerances, including reflective surfaces having a desired geometry in precise alignment with the other defined surface features.

U.S. Patent Application Publication No. US2016/0016218A1 further discloses a composite structure including a base having a main portion and an auxiliary portion of dissimilar metallic materials. The base and the auxiliary portion are shaped by stamping. As the auxiliary portion is stamped, it interlocks with the base, and at the same time forming the desired structured features on the auxiliary portion, such as a structured reflective surface, optical fiber alignment feature, etc. With this approach, relatively less critical structured features can be shaped on the bulk of the base with less effort to maintain a relatively larger tolerance, while the relatively more critical structured features on the auxiliary portion are more precisely shaped with further considerations to define dimensions, geometries and/or finishes at relatively smaller tolerances. The auxiliary portion may include a further composite structure of two dissimilar metallic materials associated with different properties for stamping different structured features. This stamping approach improves on the earlier stamping process in U.S. Pat. No. 7,343,770, in which the bulk material that is subjected to stamping is a homogenous material (e.g., a strip of metal, such as Kovar, aluminum, etc.) The stamping process produces structural features out of the single homogeneous material. Thus, different features would share the properties of the material, which may not be optimized for one or more features. For example, a material that has a property suitable for stamping an alignment feature may not possess a property that is suitable for stamping a reflective surface feature having the best light reflective efficiency to reduce optical signal losses.

The above noted patent publication can be further referenced in connection with forming the optical benches B, and further forming the passive alignment features of metal components disclose herein below.

Referring to FIG. 1A, the carrier backplate CB is commonly attached to the bases of the optical benches on a side not facing the external component. In the illustrated embodiment of FIG. 1A, at least two of the optical benches B are arranged in a lateral configuration across the carrier backplate CB, with the optical channels/optical inputs/outputs IO laterally arranged across the two optical benches. The optical benches B may be arranged with optical inputs/outputs IO in a substantially colinear arrangement. At least two optical benches B are structured to support different number of waveguides to define different number of channels of the respective optical benches.

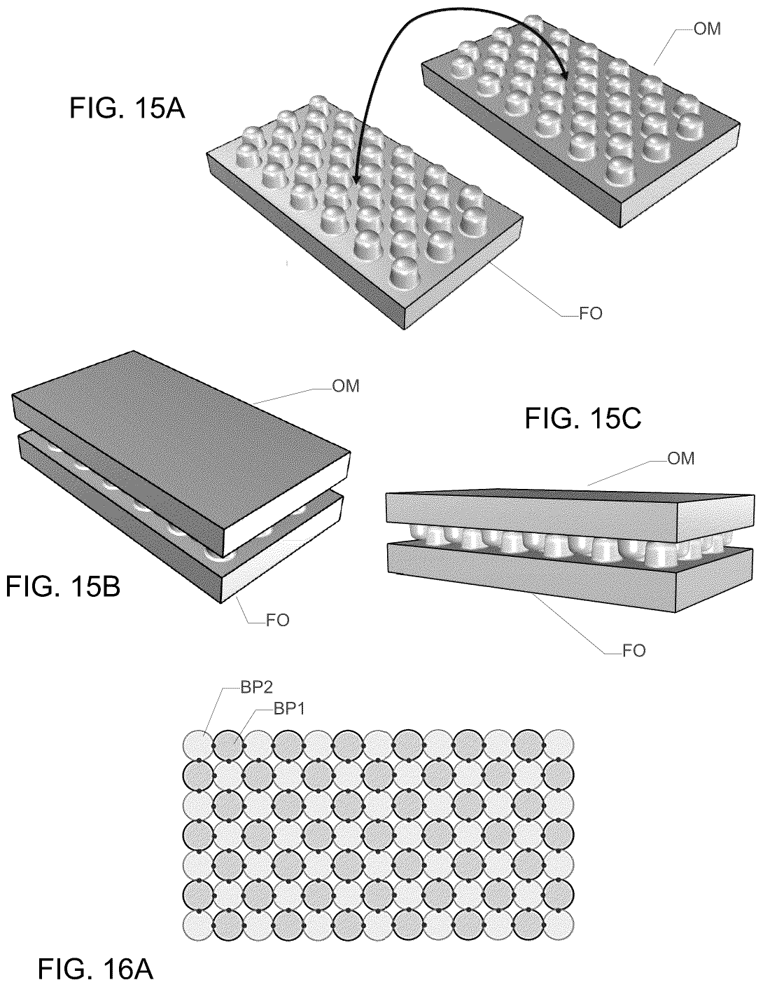

The backplate CB is structured to physically and demountably connect to the external component using passive alignment features PA (e.g., elastic averaging features) provided near the two ends of the backplate BP, on a side of the backplate CB facing the external component, as schematically shown in FIG. 1A. The structure of the passive alignment features will be discussed in greater detail in connection with further embodiments below. For example, the passive alignment features may comprise complementary elastic averaging features, such as those illustrated in FIG. 15, which will be discussed later below.

In one embodiment, the external component comprises another optical connector module of similar structure, whereby the two optical connector modules may be optically coupled to communicate optical signals. In other words, the external component to be optically coupled to by the optical connector module M is simply another similarly structured (or otherwise optically and mechanically compatible) optical connector module M′. FIG. 1B is a schematic plan view of an opposite top side of another optical connector module M′ that comprises a structure similar to the connector module M shown in FIG. 1A (in FIG. 1B, the optical benches B are hidden from view). FIG. 1C is a schematic plan view of the optical connector module M shown in FIG. 1A optically coupled to the similar optical connector module M′ shown in FIG. 1B.

The connector module M′ may be a termination of another optical fiber cable, or a terminal or connection point mounted to a circuit board PCB.

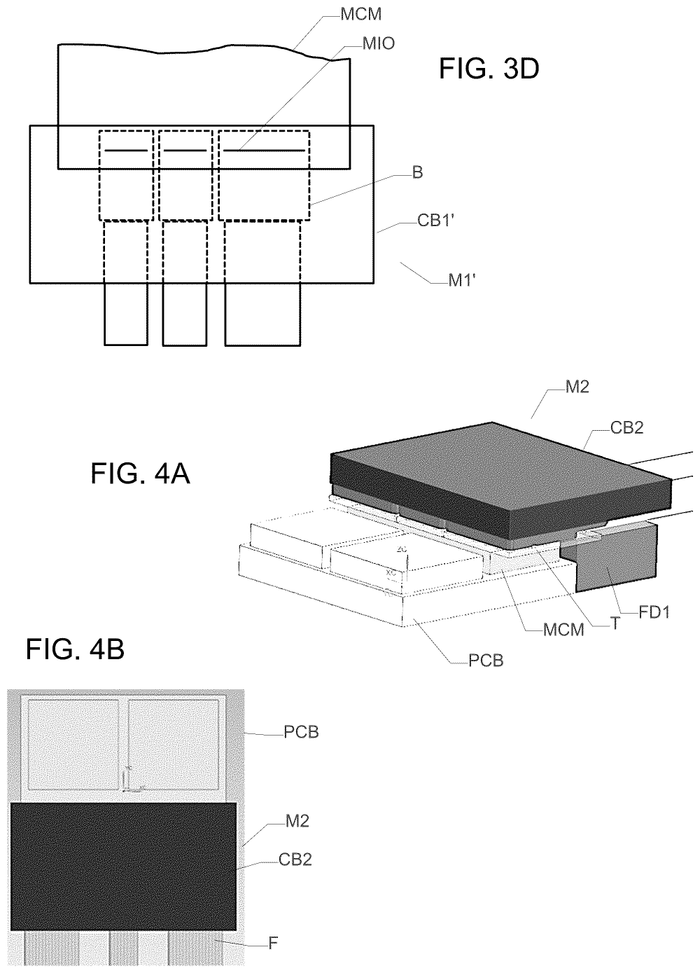

In another embodiment, the external component comprises an optical device, which may be a photonic integrated circuit (PIC), and further which may be a multichip module (MCM) comprising a plurality of discrete PICs mounted on a unifying common support. FIG. 3A is a schematic top plan view of an external component in the form of an optical multichip module (MCM) with a foundation F near an edge thereof. The MCM and the foundation F can be mounted to a printed circuit board or a receptacle (not shown). The MCM comprises optical inputs/outputs MIO. The foundation F comprises passive alignment features PA (three sets of passive alignment features PA as shown). FIG. 3B is a schematic plan view of a top side of an optical connector module M1 with the optical benches B hidden from view. The connector module M1 is generally similar to the connector module M discussed in the earlier embodiment of FIG. 1A. The optical benches B may be structured similar to FIGS. 2A and 2B. In the embodiment of FIG. 3B, the carrier backplate CB1 of the connector module M1 is provided with three sets of passive alignment features PA that are located and structured to be complementary to the passive alignment features PA on the foundation F. FIG. 3C is a schematic plan view of the optical connector module M1 of FIG. 3B demountably and optically coupled to the foundation F shown in FIG. 3A. The foundation F provides the demountable physical coupling, with the optical benches B extending to overlap the MCM input/output region. The optical inputs/outputs IO of the optical benches B are optically aligned with the input/outputs MIO of the MCM, as schematically shown in FIG. 3C.

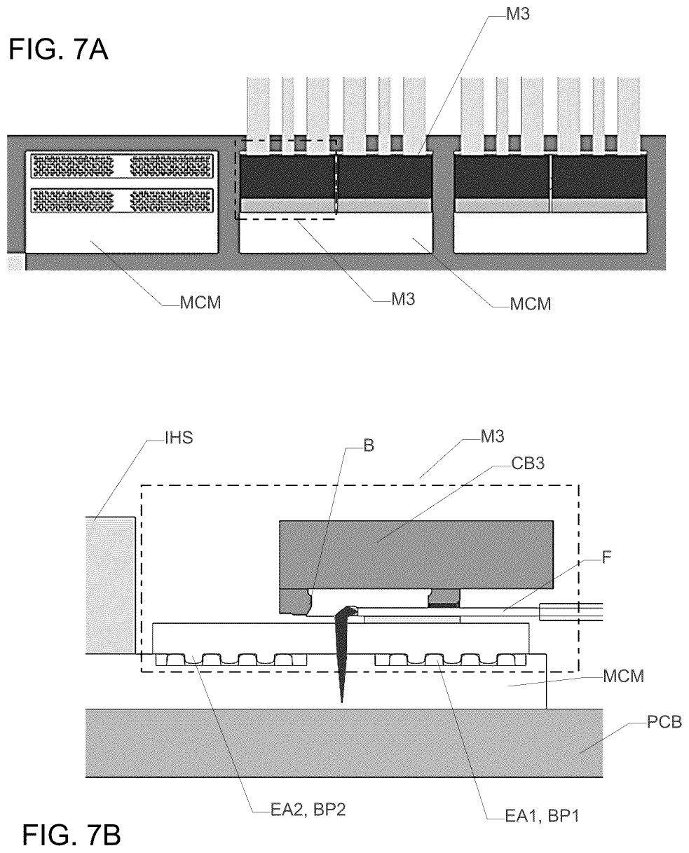

To assemble the connector module M1, its optical benches B are actively aligned to the MCM or an equivalent assembly form (which may include a ‘master MCM’, a ‘master PIC’, and/or foundation) to provide a reference for optically aligning the connector module M1 to intended MCMs. After active alignment, the backplate CB1 is fixedly attached to the back of the optical benches B (e.g., by epoxy, laser weld, solder, etc.) The use of reference ‘master MCM’ as alignment reference will be discussed in greater below in connection with the embodiments of FIGS. 7-14.

FIG. 3D is an alternate embodiment in which the optical connector module M1′ is permanently attached to the MCM. In this embodiment, the connector module M1′ is permanently attached to the MCM after active alignment of the optical benches B to the intended MCM, without implementing passive alignment features for demountable connection.

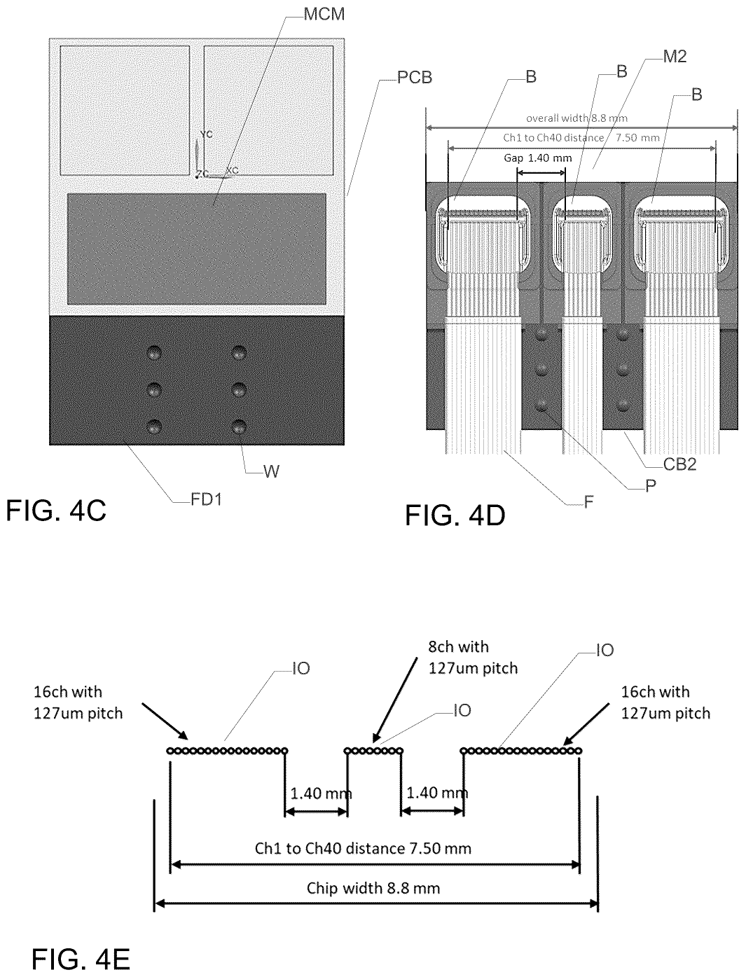

FIGS. 4A to 4E elaborate on the schematic configurations shown in FIGS. 3A to 3C. FIG. 4A is a perspective view of an optical connector module M2 physically and optically coupled to an MCM, in accordance with another embodiment of the present invention; FIG. 4B is a top plan view of FIG. 4A. The MCM is supported on a PCB, with the connector module M2 demountably coupled thereon via the foundation FD1 positioned adjacent to the MCM.

FIG. 4C is a top plan view of the MCM and the foundation FD1 having passive alignment features; FIG. 4D is a plan view of an underside of the optical connector module M2 shown in FIG. 4A with the optical benches B exposed (i.e., the optical inputs/outputs IO side). Compared to the schematics shown in FIGS. 3A to 3C, the connector module M2 is different with respect to the locations of the complementary passive alignment features relative to the MCM and on the backplate CB2, and the relative sizes of the three optical benches B.

In this embodiment, the complementary passive alignment features comprise concave cavities W (e.g., hemispherical wells) provided on the top surface of the foundation FD1 and complementary protrusions P (e.g., hemispherical protrusions) provided at complementary locations on the carrier backplate CB2. As illustrated, the protrusions P are provided on the backplate CB2 at locations between the optical fiber cables (F). The foundation FD1 may be an integral extension of the MCM body or chassis, with integrated passive alignment features.

FIG. 4E schematically illustrates the relative dimensions and positions of the inputs/outputs IO of the optical fibers F supported in the optical benches B shown in FIG. 4D. The same spatial arrangement of IO ports exists on the external device (MCM or optical connector) The inputs/outputs IO for the connector module M2 comprises 16-8-16 optical channels supported by three optical benches B.

As was explained in connection with the earlier embodiments, the optical benches are actively aligned to an assembly form (e.g., a “master MCM”) conforming to the actual MCM to which the connector module M2 will be coupled. The backplate CB1 is then fixedly attached to the body/base b of the optical benches B to fix the relative positions of the optical benches B and further in relation to the optical inputs/outputs of the MCM to thereby produce the connector module M2. The assembly form is only used during the assembly process. Once assembled, the connector module M2 is removed from the assembly form, and it can be mechanically coupled (i.e., demountably coupled using the passive alignment features) and optically coupled to an MCM that corresponds to the assembly form. The process of assembly an optical connector module involving active alignment using an assembly form will be explained further in connection with the embodiments of FIGS. 7 to 14.

Benefits of the inventive configurable optical connector module includes:
1. Flexibility in different fiber counts based on the combination of optical benches (e.g., 3 optical benches B with 16-8-16 fibers in FIG. 4).
2. One optical bench, shown in middle of the connector module, can be used with polarizing maintaining fiber so that a cable is routed to an external laser source
3. Connector module can be detachable/demountable using passive alignment features, and can achieve high repeatability accuracy based on elastic averaging alignment.
4. Connector module is low profile, with matching coefficient of thermal expansion (CTE) with the silicon chips of the MCM.

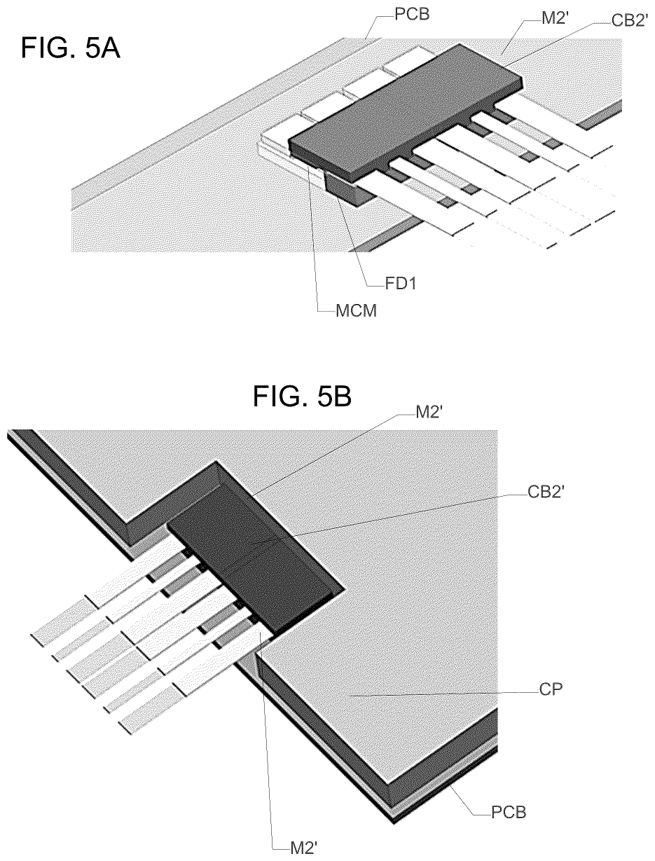

FIG. 5A is a perspective view of an optical connector module optically coupled to an MCM, in accordance with another embodiment of the present invention. In this embodiment, the optical connector module M2′ has a backplate CB2′ that supports six optical benches B, but otherwise may have similar structure as the optical connector module M2 in the previous embodiment. Other than the number of total optical channels of the connector module M2′, the structure of the connector module M2′ is similar to that of the connector module 2 in the previous embodiment.

FIG. 5B is a perspective view of an optical connector module optically coupled to the MCM adjacent to an optional cooling plate CP, in accordance with one embodiment of the present invention. Various modifications may be made to the optical connector module and the MCM to implement demountable coupling.

As noted earlier above, the carrier may comprise interfacing features for physical mating connection to the external component. For example, the interfacing features may comprise passive alignment features matching complementary passive alignment features on the external component for demountable coupling of the connector module to the external component. The carrier may be directly mounted to the top of the external component or detachably mounted to the external component via a receptacle attached to a top of the external component.

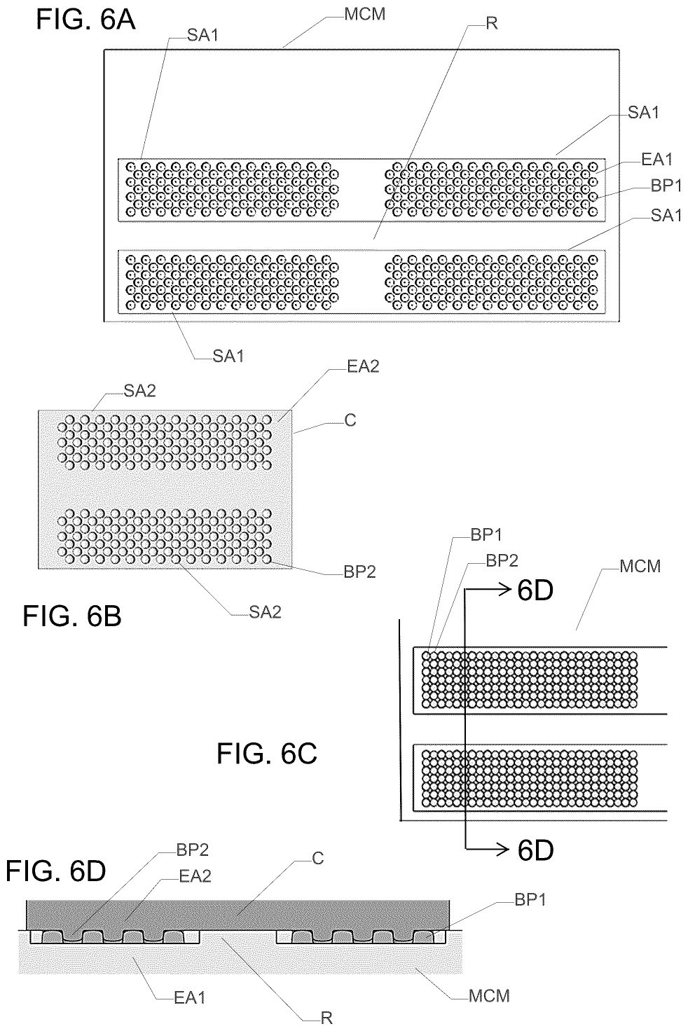

Referring to FIG. 6, passive alignment features based on elastic averaging features are provided on the MCM and the optical connector module, in accordance with one embodiment of the present invention. Specifically, FIG. 6A illustrates elastic averaging passive alignment features EA1 provided on a top surface of an MCM. FIG. 6B illustrates complementary elastic averaging passive alignment features EA2 provided on a cover plate C to be attached to the underside of an optical connector module M3. FIG. 6C is a plan view schematically illustrating the mating of the elastic averaging features when the optical connector module is demountably coupled to the top surface of the MCM. FIG. 6D is a sectional view taken along line 6D-6D in FIG. 6C.

The elastic averaging features EA1 comprises an array of discrete bumps BP1 etched into top surface of the MCM. As more clearly shown in FIG. 6D, the space separating the bumps BP1 are formed by etching the material of the MCM (e.g., silicon in the case of a silicon based MCM). As shown in FIG. 6A, the array of elastic averaging features EA1 comprises four longitudinal sub-arrays SA1, with a ridge R dividing the array of features EA1 into two longitudinal sub-arrays SA1 on each side of the ridge R. The ridge R forms a “window” for optical signals to pass through the material that is transparent to the working wavelength of the intended optical signals. As will be explained later below in connection with FIG. 7B, mirrors of the optical connector M3 are aligned to light beam input/output grating couplers in the MCM within the region of the ridge R.

The cover plate C may be made of glass or silicon that is optically transparent to the working wavelength of the intended optical signals between the optical fibers F and the MCM. Silicon is transparent to light in common infrared (IR) band for optical communications (e.g., 1310 nm-1550 nm). The elastic averaging features EA2 comprises a complementary array of bumps BP2 etched into a facing surface of the cover plate C. The array of EA2 comprises two longitudinal sub-arrays SA2 separated by a space of a width to receive the ridge between the two sub-arrays SA2.

In this embodiment, a cover plate C corresponds to one half of the array EA1 of the MCM in FIG. 6A, with the two sub-arrays SA2 matching two sub-arrays SA1, as more clearly illustrated in FIG. 7B. As schematically shown in FIG. 6C, when the cover plate C is demountably coupled to the top surface of the MCM, the corresponding sub-arrays SA1 and SA2 come into mating contacts in which the elastic averaging features EA1 and EA2 creates a generally four-point contact for each bump (BP1, BP2), other than for the bumps in the periphery of each sub-array. FIG. 6D shows the engagement of the bumps BP1 and BP2. As shown, each bump BP2 does not extend in its longitudinal axial direction to touch the MCM, while the bumps BP1 extends in its longitudinal direction to touch the cover plate C. The elastic alignment features EA1 and EA2 can be coated with material that improves tribology (lowers friction, decreases wear, etc.). An example is silicon nitride.

The configuration of the elastic averaging features illustrated in FIG. 6 is novel and is the subject matter of another patent application that claims common priority of a first file application. For the sake of completeness, the structural configuration of the elastic averaging features is further discussed in reference to FIG. 15 below.

FIG. 7A illustrates demountable coupling of an optical connector module M3 having a cover plate to an MCM, which implements the elastic averaging features discussed above. FIG. 7B is a sectional view. FIG. 7A shows three MCMs arranged in a row. Each MCM takes on two optical connector modules M3 arranged side-by-side. The MCM to the far left in FIG. 7A corresponds to FIG. 6A.

As was in the case of the earlier embodiments, the carrier in the connector module M3 comprises interfacing features for physical mating connection to the external component (i.e., the MCM in this case). In this embodiment, referring to FIG. 7B, the carrier of the connector module M3 comprises a backplate CB3 and a cover plate C as discussed above in FIG. 6, which sandwich the optical benches therebetween. The demountable interfacing features comprise the above discussed passive alignment features EA2 matching complementary passive alignment features EA2 on the MCM for demountable coupling of the connector module to the MCM. In this embodiment, the carrier cover plate C is detachably mounted directly to the MCM. The elastic averaging passive alignment features on the cover plate C can be formed by lithography and etching. Conforming alignment features are etched into the MCM.

The cover plate C can be silicon, which is transparent to light in common IR band for optical communications (1310 nm-1550 nm). As shown in FIG. 7B, light beams can pass through the silicon cover plate C between the optical bench B and the MCM.

In this embodiment, an internal heat spreader IHS is provided above the MCM.

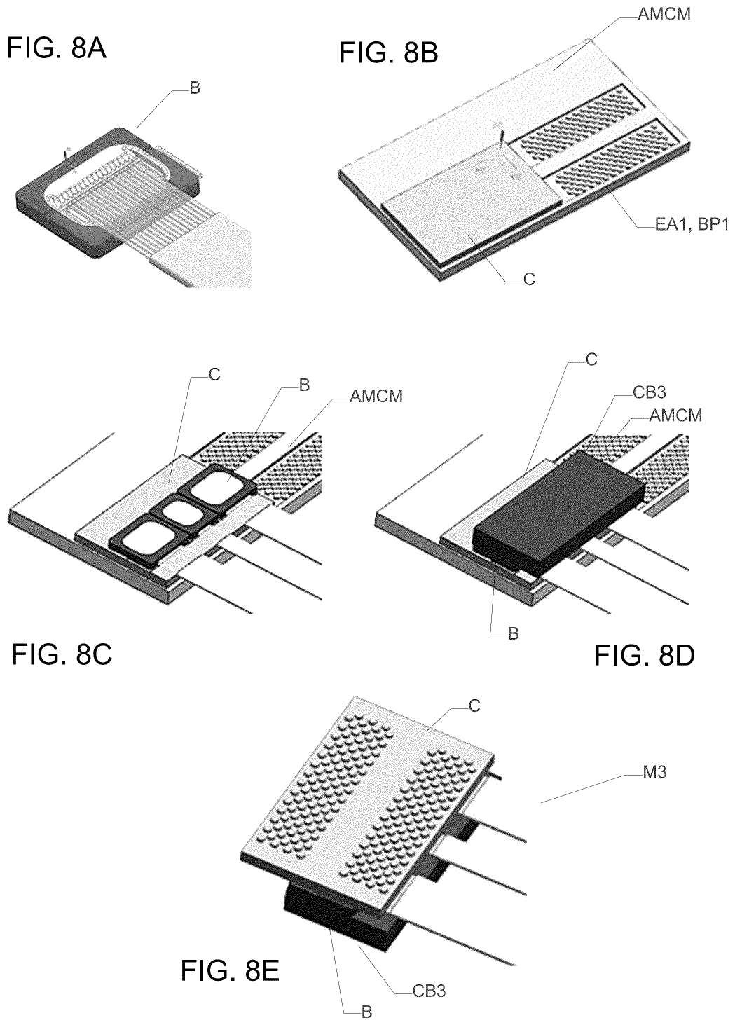

FIGS. 8A to 8E illustrate the process of assembling the optical connector module shown in the embodiment of FIGS. 7A and 7B, in accordance with one embodiment of the present invention. In FIG. 8A, appropriate optical benches B are selected, which can be configured similar to the embodiment in FIG. 2A or 2B, with the desired number of optical channels/optical fibers. In FIG. 8B, the silicon cover plate (with alignment features) is demountably attached to an assembly form such as an assembly MCM (AMCM) which has same grating coupler (GC) position and elastic averaging passive alignment features as the actual MCM. AMCM mimics actual silicon photonic integrated circuits (PIC) used in MCM, but the AMCM is only used during assembly processes. The AMCM has optical waveguides and GCs that can be used for active alignment of the optical benches B prior to being fixedly attached to the carrier (cover plate C and backplate CB3 in this embodiment). The GC has loopback connection to allow for active alignment of the optical benches B in subsequent steps in the assembly process. This loopback active alignment process may be referenced to the optical passive alignment of an optical connector assembly to an optoelectronic device in the process disclosed in U.S. Pat. No. 9,897,769B2 commonly assigned to the assignee of the present application.

In FIG. 8C, the optical benches B are positioned on the cover plate C, with the inputs/outputs IO of the optical bench B facing the MCM. The mirrors MM/optical fibers F in the optical benches are actively aligned to the loopback GCs in the AMCM under same load condition. Upon reaching desired alignment position, the body of each optical bench is fixedly attached to the cover plate C (e.g., by epoxy, laser welding, soldering, etc.). In FIG. 8D, the backplate CB3 is fixed attached to the top surfaces (as shown in FIG. 8C) of the optical benches B (e.g., by epoxy, laser welding, soldering, etc.). FIG. 8E shows the assembled connector module M3 (flipped over), after it is removed from the AMCM. The connector module M3 in this completed configuration is ready for use to demountably couple to an actual MCM with conforming optical input/output configurations and passive alignment features EA1 on the MCM (see FIG. 7B).

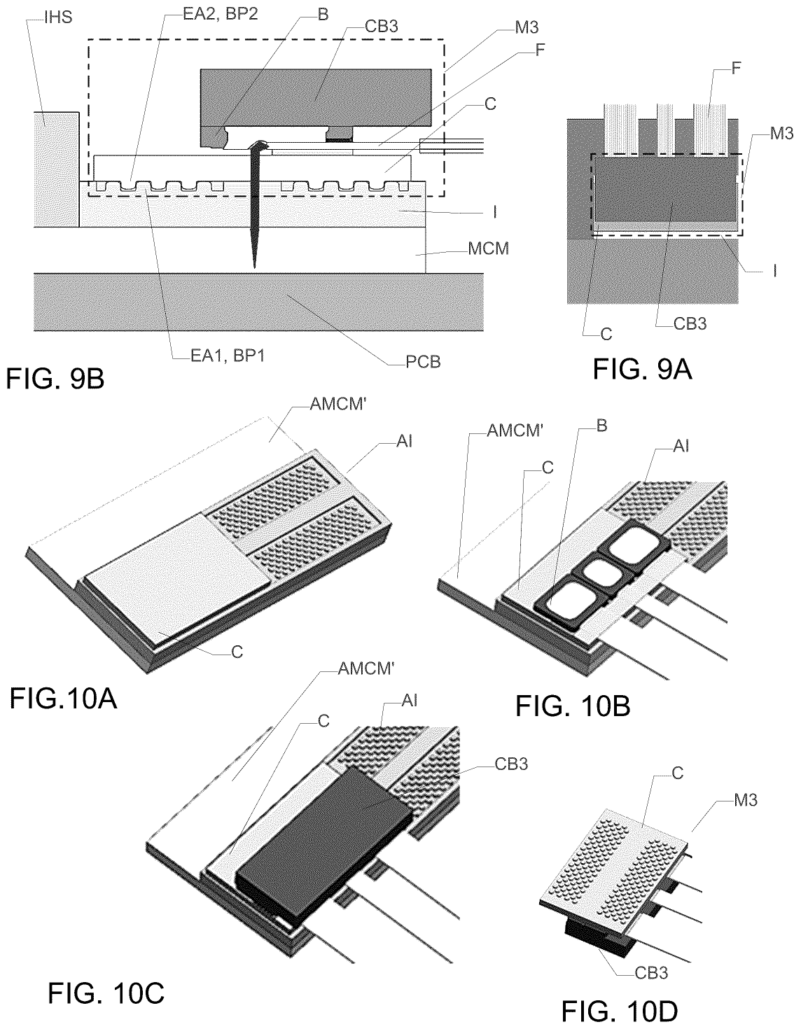

FIG. 9A illustrates demountable coupling of an optical connector module having a cover plate to an MCM via a receptacle, in accordance with another embodiment of the present invention; FIG. 9B is a sectional view. The configuration of the optical connector module M3 is no different from the optical connector module M3 in the previous embodiment. Compared to the previous embodiment of FIG. 7, the actual MCM now includes a receptacle I attached to the top of the MCM, wherein the receptacle I is a separate structure that provides the passive alignment features EA1. Specifically, the mechanical receptacle I made of silicon (transparent to the working wavelength of optical signals) is permanently attached to the MCM. The receptacle protects the MCM. In this embodiment, the detachable/demountable interface is shifted to between the mechanical receptacle I and the silicon cover plate C of the optical connector module M3.

FIGS. 10A to 10D illustrate the process of assembling the optical connector module shown in the embodiment of FIGS. 9A and 9B, in accordance with one embodiment of the present invention. Similar to the process discussed in the previous embodiment, appropriate optical benches B are selected. In FIG. 10A, instead of using an AMCM having elastic averaging alignment features thereon as was in the case of the previous embodiment, a similar AMCM′ without passive alignment features but having an optically transparent assembly receptacle AI with passive alignment features is used in place of the previous AMCM. In this embodiment, with the assembly receptacle AI is attached to the top of the AMCM′, such overall structure provides both alignment features and optical waveguides and GCs that can be used for active alignment of the optical benches B as was in the earlier embodiment. The rest of the assembly process is similar to the previous embodiment. In FIG. 10A, a cover plate C is demountably coupled to the assembly receptacle AI via the complementary passive alignment features (in this case elastic averaging features). In FIG. 10B, the selected optical benches B are actively aligned to the AMCM′ and fixedly attached to the cover plate C. In FIG. 10C, a backplate CB3 is fixedly attached to the top of the optical benches B. The assembled optical connector module M3 is similar to the optical connector module M3 in the previous embodiment. The connector module M3 in this completed configuration is ready for use to demountably couple to an actual MCM with conforming optical input/output configurations and passive alignment features EA1 on a receptacle I (see FIG. 9B).

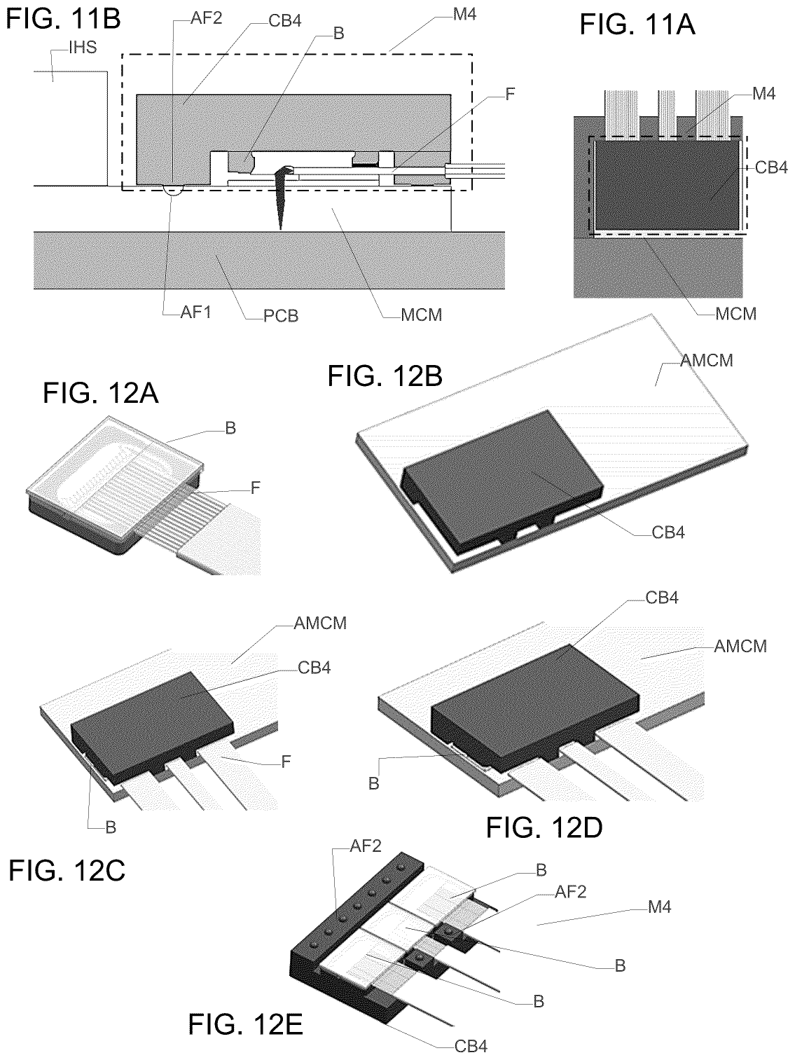

FIG. 11A illustrates demountable coupling of an optical connector module to an MCM, in accordance with another embodiment of the present invention; FIG. 11B is a sectional view. In this embodiment, the optical connector module M4 is mechanically aligned to the MCM using a pattern of demountable passive alignment features AF1 and AF2 provided on the facing surfaces of the top side of the MCM and the carrier backplate CB4. The passive alignment features could be kinematic or quasi-kinematic coupling features, or elastic averaging features if there is sufficient interface surface area. On the MCM, the alignment features AF1 could be cavities or wells (e.g., conical, pyramidal or hemispherical) distributed across the top surface of the MCM (which could be similar to the distribution shown on the receptacle I′ in FIG. 14A). The backplate CB4 has an edge that extends beyond the optical benches B and downwards towards the MCM. Complementary alignment features AF2 (e.g., hemispherical protrusions) are provided on the distal end face of this extending edge, as well as on the end face of protruded portions in between fiber cables of adjacent optical benches B, as shown in FIG. 12E, In this embodiment, given a cover plate C is not deployed in the optical connector module, less surface area is available on the backplate CB4 to implement arrays of elastic averaging features as the interfacing surface features for passive alignment. Without a relatively larger area needed for elastic averaging, the planar dimensions of the backplate CB4 can be minimized for the optical connector module M4.

FIGS. 12A to 12E illustrate the process of assembling the optical connector module shown in the embodiment of FIGS. 11A and 11B, in accordance with one embodiment of the present invention. In FIG. 12A, appropriate optical benches B are selected and provided. In FIG. 12B, the backplate CB4 (with passive alignment features AF2) is demountably coupled to an assembly MCM (AMCM). As was in the earlier embodiment of FIG. 8, the AMCM in this embodiment has same GC position and alignment features as the actual MCM, but with different passive alignment features AF1 instead of the elastic averaging features EA1 formed at the top of the AMCM. The GC has loopback connection. In FIG. 12C, the selected optical benches B are inserted in between the AMCM and the backplate CB4. As was in the earlier embodiment, the optical benches B are actively aligned to the AMCM using AMCM's loopback GC under same load condition. Then in FIG. 12D, after active alignment, the optical benches B are fixedly attached to the backplate CB4. In FIG. 12E, the completed connector module M4 is removed from the AMCM. The connector module M4 in this completed configuration is ready for use to demountably couple to an actual MCM with conforming optical input/output configurations and passive alignment features AF1 (see FIG. 11B).

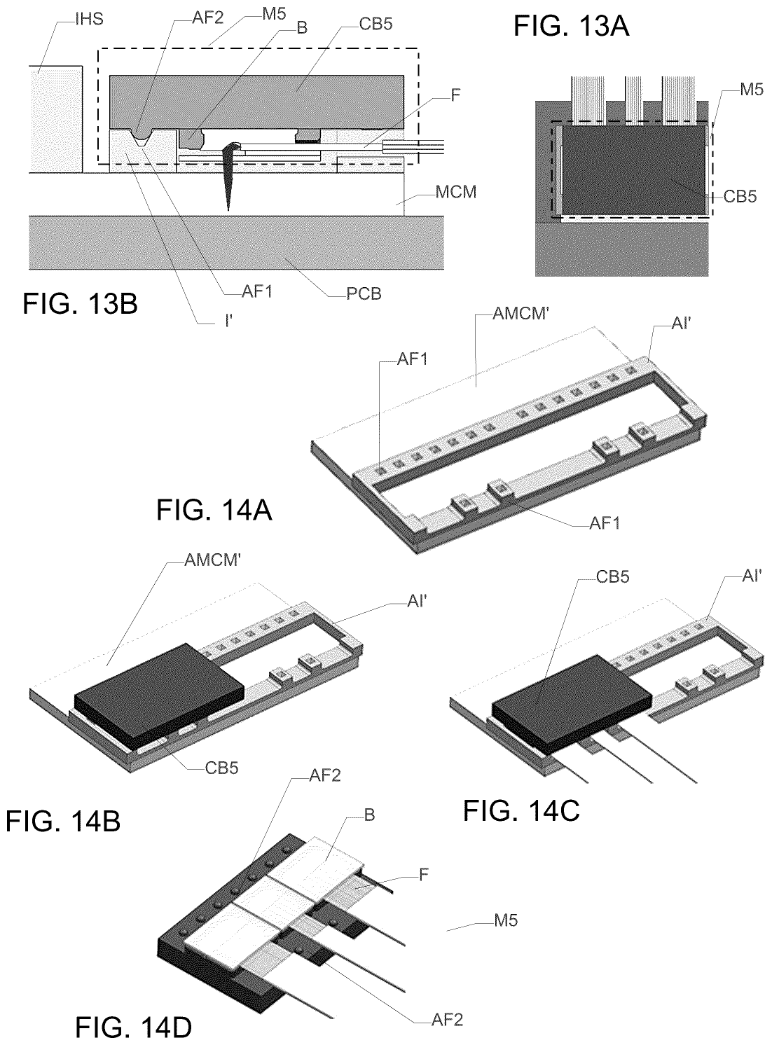

FIG. 13A illustrates demountable coupling of an optical connector module M5 to an MCM via a receptacle I′, in accordance with one embodiment of the present invention; FIG. 13B is a sectional view. In this embodiment, a mechanical receptacle I′ is deployed on the top of the MCM for demountable coupling to the backplate CB5. The configuration of the optical connector module M5 is substantially similar to the optical connector module M4 in the previous embodiment, except there is no depending extended edge of the backplate CB5. Compared to the previous embodiment of FIG. 9, the actual MCM now includes a receptacle I′ attached to the top of the MCM, wherein the receptacle I′ is a separate structure that provides the passive alignment features AF1, which is complementary to the alignment features AF2 provided on the backplate CB5. Specifically, the mechanical receptacle I′ is a frame structure permanently attached to the top of the MCM. Given the open frame structure, the receptacle I′ no longer needs to be transparent to optical signals. In this embodiment, like the embodiment of FIG. 9, the detachable/demountable interface is shifted to between the mechanical receptacle I′ and the backplate CB5 of the optical connector module M5.

The passive alignment features could be kinematic or quasi-kinematic coupling features, or elastic averaging features if there is sufficient interface surface area. On the receptacle I′, the alignment features AF1 could be cavities or wells (e.g., conical, pyramidal or hemispherical) distributed across the top surface of the receptacle I′. The backplate CB5 has a portion that extends beyond the optical benches B. Complementary alignment features AF2 (e.g., hemispherical protrusions) are provided on the underside of this extending portion, as well as on the end face of protruded portions in between fiber cables of adjacent optical benches B, as shown in FIG. 14D (similar to the previous embodiment shown in FIG. 12E).

FIGS. 14A to 14D illustrate the process of assembling the optical connector module shown in the embodiment of FIGS. 13A and 13B, in accordance with one embodiment of the present invention. Similar to the process discussed in the previous embodiments, appropriate optical benches B are selected and provided. In FIG. 14A, instead of using an AMCM having passive alignment features AF1 thereon as was in the case of the previous embodiment of FIG. 12, a similar AMCM′ without passive alignment features but having the assembly receptacle AI′ with passive alignment features AF1 is used in place of the previous AMCM in FIG. 12. In this embodiment, with the assembly receptacle AI′ is attached to the top of the AMCM′, such overall structure provides both alignment features and optical waveguides and GCs that can be used for active alignment of the optical benches B as was in the earlier embodiment.

The rest of the assembly process is similar to the previous embodiment. In FIG. 14B, the backplate CB5 (with passive alignment features AF2) is demountably coupled to the assembly receptacle AI′ on the AMCM′. In FIG. 14C, the selected optical benches B are inserted in between the AMCM′ and the backplate CB5. As was in the earlier embodiment, the optical benches B are actively aligned to the AMCM′ using loopback GC on the AMCM′ under same load condition. Then after active alignment, the optical benches B are fixedly attached to the backplate CB5. In FIG. 14D, the completed connector module M5 is removed from the AMCM. The connector module M5 in this completed configuration is ready for use to demountably couple to an actual MCM with conforming optical input/output configurations and passive alignment features AF1 (see FIG. 13B).

The above disclosed backplates may be metallic, having surface features formed by metal stamping, by processes that could be similar to the metal stamping processes referenced above for stamp forming the metallic optical benches B.

FIG. 15A schematically illustrates complementary elastic averaging features that may be implemented at opposing mating surfaces at an optical connector module side OM and a foundation side, which may be an MCM, a receptacle or foundation (collectively “foundation” side FO), in accordance with one embodiment of the present invention; FIGS. 15B and 15C illustrate perspective and side views of demountable coupling between the connector side OM and the foundation side FO. The elastic averaging features are similar to the elastic averaging features EA1 and EA2 discussed in connection with FIG. 6.

The characteristics of the illustrated elastic averaging coupling include:
a. Improved accuracy by averaging of errors with quantity of contact points in an array
b. Stiffer than exact-constraint
c. Higher load capacity (due to multiple contact points)
d. Nearly as repeatable as exact-constraint
e. Multiple detachable cycles
f. Elastic deformation confined to compliant structures
g. Some preload force necessary
h. Improved structural dynamics if not too compliant (with shorter unsupported spans and more damping)

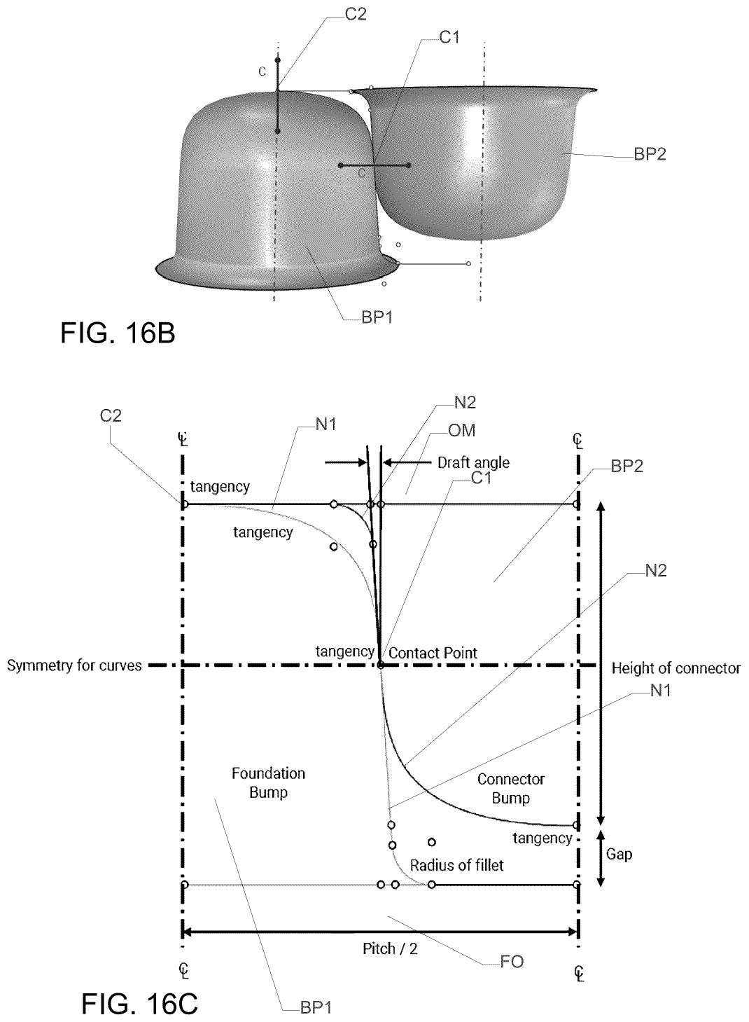

Referring also to FIGS. 6A to 6D, for this elastic averaging coupling, constraints are established by point contacts. FIG. 16A schematically illustrates the contact points between complementary arrays of elastic averaging features. FIG. 16B is a schematic perspective view illustrating contacts between complementary bumps BP1 and BP2 in the complementary arrays of elastic averaging features. FIG. 16C is a schematic graphical view illustrating contacts between complementary bumps BP1 and BP2 in the complementary arrays of elastic averaging features.

Referring also to FIG. 16C, the single contact point C1 between each pair of bumps are due to:
1. Convex radii of curvature on both bodies
2. Draft slope on side walls of bumps

There is a further single contact C2 at the apex of lower bump BP1 at the foundation side. The apex of the upper bump BP2 at the connector side does not contact the foundation, with a gap between the apex of the upper bump and the foundation.

In one embodiment, the bumps BP1 and BP2 are constructed by revolving non uniform rational b-spline (NURBS) curves around two axes, as further schematically illustrated in FIG. 16C. The parametric geometry defining convex bumps BP1 and BP2 include the following characteristics:
a. Convex bumps BP1 and BP2 are parametrically defined using NURBS curves N1 and N2
b. The curves N1 are revolved about left centerline to construct foundation bump BP1
c. The curves N2 are revolved about right centerline to construct connector bump BP2
d. Contact C1 is made at symmetry line for the curves N1 and N2.
e. Tangency is present at each contact point

The demountable passive alignment coupling between the optical connector module and the external component is defined without use of any complementary alignment pin and alignment hole. While the disclosed embodiments adopted a specific elastic averaging coupling involving specific elastic averaging features, it is understood that the inventive optical connector module can implement other types of elastic averaging features without departing from the scope and spirit of the present invention. For example, US Patent Publication No. 2016/0161686A1 and U.S. Pat. No. 11,500,166B2 disclose elastic averaging features suitable for connection of an optical connector to a support foundation. Furthermore, the optical connector module and external component/foundation may be demountably coupled and passively aligned with one another using a passive mechanical alignment other than elastic averaging, such as kinematic or quasi-kinematic alignment, constructed from various geometric features on the two bodies. The present invention is not limited to any specific demountable coupling with passive alignment.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

1. An optical connector module for optical coupling to an external component, comprising:
a plurality of discrete optical benches inputting/outputting optical signals, each comprising: a base defining an array of reflective surfaces and supporting an array of optical waveguides defining optical channels with inputs/outputs in optical alignment with corresponding reflective surfaces, thereby forming optical inputs/outputs of the optical bench;
a carrier commonly supporting the optical benches, with the optical benches fixedly mount thereon in a desired spatial arrangement with the optical inputs/outputs of the optical benches matching optical inputs/outputs of the external optical component, wherein the carrier is structured to physically connect to the external component,
whereby with the connector module connected to the external optical component, optical signals are coupled between the optical waveguides in the optical benches and the external component.
